(19) United States
(12) Patent Application Publication
(10) Pub. No.: US 2008/0008788 A1
(43) Pub. Date: Jan. 10, 2008

(54) STORAGE DEVICE COUPLED TO AN ALIMENT

(76) Inventor: Raz BEN SHOAN, Neve Yamin (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/773,984

(22) Filed: Jul. 6, 2007

Related U.S. Application Data
(63) Continuation of application No. PCT/IL2007/000571, filed on May 10, 2007.
(60) Provisional application No. 60/799,354, filed on May 11, 2006.

(51) Int. Cl. A23G 3/00

(52) U.S. Cl. 426/90

(57) ABSTRACT

The present invention discloses a storage device that includes a stick handle that is coupled to an aliment and a housing designed to accommodate an item. The housing includes an opening that enables a user of the aliment to take out the item from the housing. The item is at least one of the following: a napkin, a flyer and a game. The housing may be integrated within the stick handle of the storage device. Alternatively, the housing may be detachably coupled to the stick handle of the storage device.

### CROSS-REFERENCE TO RELATED APPLICATIONS

This US patent application claims priority from application PCT/IL2007/000571, filed May 10, 2007, which claims priority from U.S. provisional patent application 60/799354, filed May 11, 2006.

### FIELD OF INVENTION

This invention relates generally to stick handles. More specifically, this invention relates to stick handles which serve as a handle for aliments.

### BACKGROUND OF THE INVENTION

There is hardly no one who has not encountered the annoying situation, in which your child came back from kindergarten or school after eating an aliment such as, for example, a Popsicle, and all of his face was dirtied with the remains of the aliment. If the aliment is a Popsicle, the eating thereof in a sunny day will most commonly result in a sticky, messy outcome.

### SUMMARY OF EMBODIMENTS OF THE INVENTION

The present invention discloses a storage device that includes a stick handle that is coupled to an aliment and a housing designed to accommodate an item, wherein the housing includes an opening that enables a user of the aliment to take out the item from the housing.

In embodiments of the invention, the item is at least one of the following: a napkin, a flyer and a game.

In embodiments of the invention, the housing is integrated within the stick handle of the storage device.

In embodiments of the invention, the housing is detachably coupled to the stick handle of the storage device.

In embodiments of the invention, the housing is a hollow shaft within the stick handle.

In embodiments of the invention, the housing is closeable such the item therein is not subjected to the aliment.

In embodiments of the invention, the stick handle is coupled to the aliment by means of at least partially pushing the stick handle into the aliment. Other methods may be used for coupling the stick handle to the aliment.

In embodiments of the invention, the aliment is at least one of the following: a Popsicle and a fruit.

In embodiments of the invention, an opening via which the item may be taken out by the user, is closeable by a detachable cap.

In embodiments of the invention, the housing includes a slit that is slightly narrower than the widest width of a posterior portion of the stick handle, such that the posterior portion of the stick handle is able to frictionally receive the housing.

In embodiments of the invention, the housing comprises at least one stopper that is positioned such that stick handle is slidably insertable into the housing only up to the portion in which the item is accommodated.

In embodiments of the invention, a side of the housing has a cutout section that extends to about the center of the housing, thus enabling the user easy access to the item.

in embodiments of the invention, the housing and the stick handle have a substantially cylindrical shape, wherein the inner diameter of the housing is slightly larger than the outer diameter of the stick handle, such that the stick handle is designed to frictionally receive the housing.

In embodiments of the invention, the stick handle includes a substantially cylindrical element that is fixedly coupled proximate to the posterior end of stick handle. The substantially cylindrically element may include a first and a second substantially cylindrical surface that are approximately concentrically aligned. The diameter of the first substantially cylindrical surface, which is proximate to the posterior edge of the stick handle, is slightly larger than the inner diameter of the housing. Therefore, the first cylindrical surface is able to frictionally receive the housing.

In embodiments of the invention, the second substantially cylindrical surface is anterior with respect to the first substantially cylindrical surface and has a diameter that may correspond to the outer diameter of the housing. In embodiments of the invention, the second substantially cylindrical surface has a diameter that exceeds the outer diameter of the housing. Thusly configured, the second substantially cylindrical surface provides a stopper function that limits the further frictional receiving of the housing.

In embodiments of the invention, the first and the second substantially cylindrical surface are integrally formed with each other.

In embodiments of the invention, the first and the second substantially cylindrical surfaces are joined to each other.

The present invention further discloses a method for inserting a napkin into a stick handle coupled to an aliment. In embodiments of the invention, the method may include, for example, the act of opening a housing of the storage device.

In embodiments of the invention, the method may include, for example, the act of inserting napkin into the housing.

In embodiments of the invention, the method may include, for example, the act of closing the housing.

In embodiments of the invention, the method may include, for example, the act of coupling the stick handle into the aliment by, for example, pushing the stick handle into the aliment.

### BRIEF DESCRIPTION OF THE DRAWINGS

The subject matter regarded as the invention will become more clearly understood in light of the ensuing description of embodiments thereof, given by way of example only, with reference to the accompanying figures (FIGs.), wherein:

FIG. 1A is a schematic side view illustration a stick handle coupled to aliment, according to an embodiment of the invention;

FIG. 1B is a schematic side view illustration of the stick handle, wherein the caps of respective ends of the stick handle are detached therefrom, according to an embodiment of the invention;

FIG. 1C is a schematic side view illustration of the stick handle storing in a housing thereof an item, wherein the caps of respective ends of the stick handle are detached therefrom, according to an embodiment of the invention;

FIG. 1D is a schematic side view illustration of the item, according to an embodiment of the invention;

FIG. 2A is an isometric illustration of a housing storing therein the item, wherein the housing is detached from a stick handle, according to another embodiment of the invention;

FIG. 2B is an isometric illustration of the housing connected to the posterior portion of the stick handle, according to the embodiment of FIG. 2A;

FIG. 3A is an isometric illustration of a housing storing therein the item, wherein the housing is detached from a stick handle, according to an alternative embodiment of the invention;

FIG. 3B is an isometric illustration of the housing connected to the posterior portion of the stick handle, according to the embodiment of FIG. 3A; and

FIG. 4 is a flow-chart illustration of a method for inserting an item into a stick handle.

The drawings taken with description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical elements.

### DESCRIPTION OF EMBODIMENTS OF THE INVENTION

The present invention describes a storage device comprising a stick handle that is coupled to an aliment. The storage device includes a housing that may be, in one embodiment of the invention, integrated with a stick handle of the storage device. In some other embodiments of the invention, the housing is detachably coupled to the stick handle.

The housing is designed to accommodate therein an item, which a user of the aliment may easily take out. Such an item may be, for example, a napkin, a moist napkin, a flyer, a game or any suitable item. For example, the user may use a napkin held in the housing for the cleaning of his/her face while consuming the aliment. Therefore, the experience of eating an aliment that is coupled to a housing having a napkin accommodated therein may be much more pleasant for the user as he or she does not have to worry to have a napkin at hand. Storage device may have various shapes, as will be outlined hereinbelow.

An embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting, and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other than the ones outlined in the description below.

It should be understood that the terms “including”, “comprising”, “consisting” and grammatical variants thereof do not preclude the addition of one or more components, features, steps, integers or groups thereof and that the terms are not to be construed as specifying components, features, steps or integers.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The terms “bottom”, “below”, “top” and “above” and the like that may be used herein do not necessarily indicate that a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both such as when viewing them in the figures.

It should be understood that the term “posterior” with reference to a stick handle as used herein refers to the portion of the stick handle that is being grabbed by the user thereof. Consequently, the term “anterior” as used herein with reference to a stick handle refers to the portion of the stick handle that is coupled to the aliment.

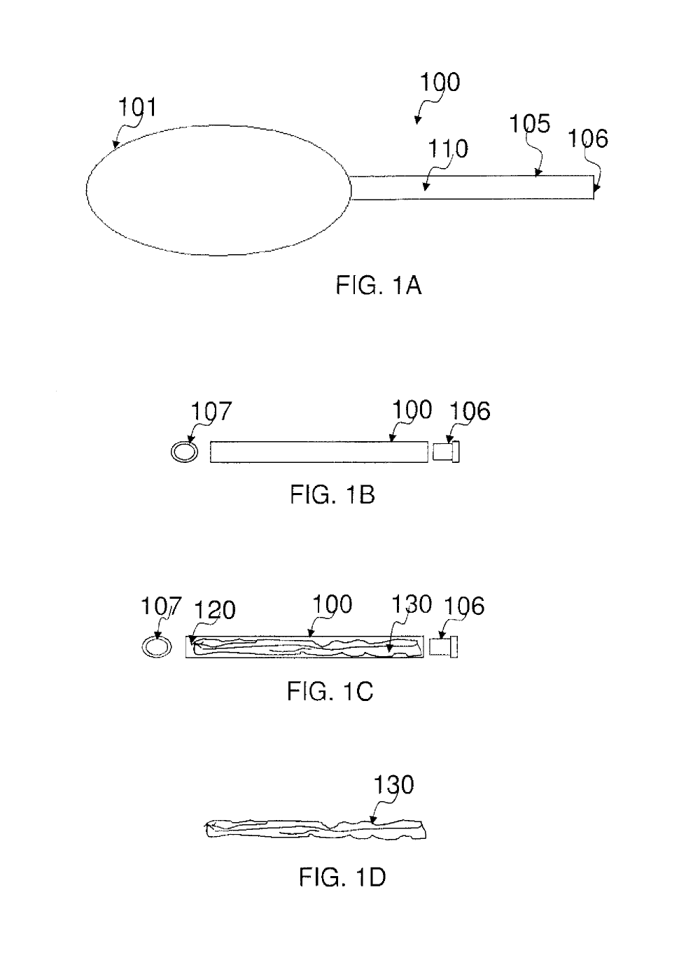

Reference is now made to FIG. 1A. According to an embodiment of the invention, a storage device 100 may include a stick handle 105 that is coupled to an aliment 101 by a method as known in the art. Stick handle 105 enables a user thereof to eat aliment 101 without the need of touching aliment 101 with his/her hands.

Further reference is now made to FIG. 1B, FIG. 1C and FIG. 1D. In an embodiment of the invention, a housing 110 is integrated within stick handle 105 of storage device 100. Housing 110 may be, for example, a hollow shaft within stick handle 100.

In some embodiments of the invention, housing 110 may have closeable openings at each of its ends, while each end may be closeable by respective caps 106 and 107. In another embodiment of the invention, cap 107 may not be detachable. f

According to an embodiment of the invention, an item 130 may be inserted into housing 110 of stick handle 105 by, e.g., the user. Item 130 may be secured within housing 110 by closing or sealing the openings thereof with cap 106, thereby enabling coupling stick handle 105 to aliment 101 without subjecting item 130 to aliment 101. It may be noted that aliment 101 may be a candy, a Popsicle, a fruit and the like.

According to an embodiment of the invention, cap 106 and stick handle 105 are configured such that the user can easily detach cap 106 therefrom for pulling out from and returning item 130 into housing 110. After returning of item 130 into housing 110, the user may close the housing with cap 106.

According to some embodiments of the invention, stick handle 105 may have various geometries. For example, the cross-sectional front view of stick handle 105 may have a substantially rectangle, a substantially triangle, a substantially oval, a substantially circle shaped cross-sectional front view. Moreover, geometries of cross-sectional front view may vary between different locations along stick handle 105. For example, the cross section along stick handle 105 may change from a rectangular shape in one location to a substantially circular shape in another location.

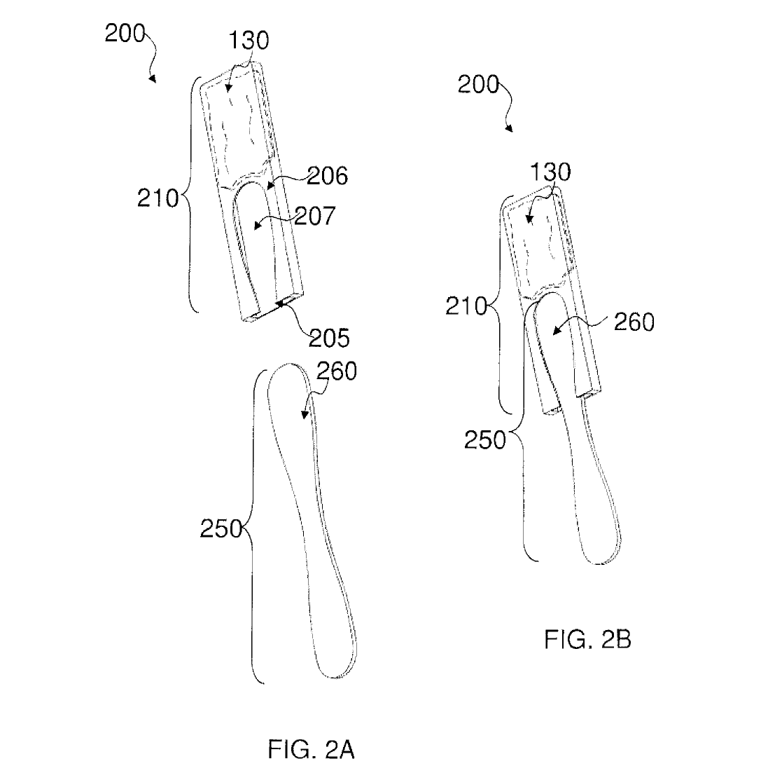

Reference is now made to FIG. 2A and FIG. 2B. According to some embodiments of the invention, a storage device, which includes a housing 210, is configured to detachably fit on a stick handle 250. Housing 210 may have a slit 205 that is slightly narrower than the widest width of a posterior portion 260 of stick handle 250. Thusly configured, posterior portion 260 is able to frictionally receive housing. 210

According to some embodiments of the invention, housing 210 and/or stick handle 250 may include one or more stoppers (not shown) that are positioned such that stick handle 250 is slidably insertable into housing 210 only up to the portion of housing 210 in which item 130 is accommodate to avoid the creasing or crumpling of item 130 by posterior portion 260 of stick handle 250. According to some embodiments of the invention, a side 206 of housing 210 may have a cutout section 207 that may extend to about the center of housing 210, thus enabling the user easy access to item 130.

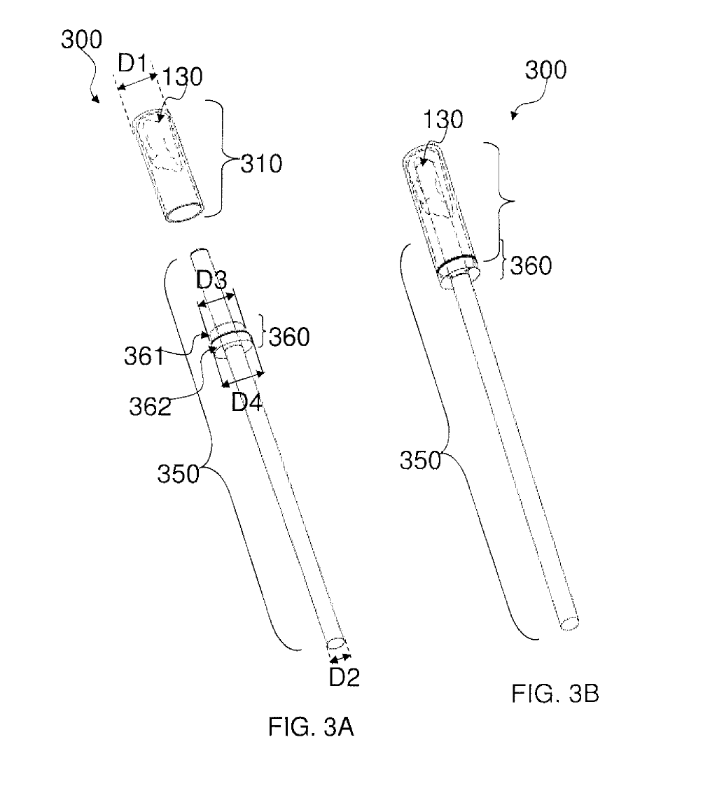

Reference is now made to FIG. 3A and to FIG. 3B. As already mentioned above, a storage device such as storage device 250 may have various shapes. For example, a housing 310 and a stick handle 350 of storage device 250 may both have a substantially cylindrical shape.

In some embodiments of the invention, housing 310 may have an inner diameter D1 that is slightly larger than the diameter D2 of stick handle 350. Thus configured, stick handle 350 can frictionally receive housing 310. Accordingly, housing 310 is detachably connectable to stick handle 350.

According to some embodiments of the invention, a stick handle such as, for example, stick handle 350, may include a substantially cylindrical element 360 that is fixedly coupled proximate to the posterior end of stick handle 350. Cylindrical element 360 may include a first and a second substantially cylindrical surface 361 and 362 having diameters D3 and D4, respectively. First substantially cylindrical surface 361 is proximate to the posterior end of stick handle 210. First and second substantially cylindrical surfaces 361 and 362, respectively, are approximately concentrically aligned and are either joined to or integrally formed with each other. In some embodiments of the invention, the diameter D3 of first cylindrical surface 361 is slightly larger than the inner diameter D1 of housing 310, such that first cylindrical surface 361 is able to frictionally receive housing 310. Consequently, housing 310 is detachably connectable to stick handle 350. Furthermore, second substantially cylindrical surface 362 has a diameter D4 that corresponds to or exceeds the outer diameter of housing 310. Thus, second substantially cylindrical surface 362 may be designed to provide a stopper function limiting the frictional receiving of housing 310.

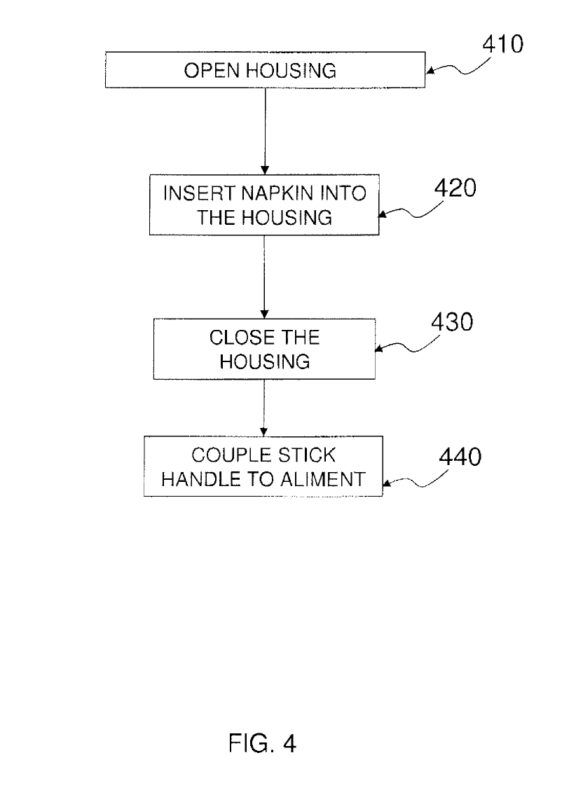

Reference is now made to FIG. 4. As indicated by box 410, the method may include, for example, the act of opening a housing such as, for example, housing 110, by removing cap 106 therefrom. Additionally or alternatively, this may be accomplished, for example, by detaching housing 210 from stick handle 250 and/or by detaching housing 310 from stick handle 350.

As indicated by box 420, the method may include, for example, the act of inserting an item into the housing. For example, item 130 may be inserted into housing 110 or housing 210.

As indicated by box 430, the method may include, for example, the act of closing the housing. This act may be accomplished, for example, by closing housing 110 with cap 106. Alternatively, this act may be accomplished, for example, by frictionally sliding housing 210 over posterior portion 260 of stick handle 250.

As indicated by box 440, the method may include, for example, the act of coupling a stick handle such as, for example, stick handle 105, stick handle 250 or stick handle 350, to an aliment such as, for example, aliment 101. Aliment 101 may be, for example, a Popsicle; a candy; a fruit such as an apple; and the like. The coupling of the stick handle to the aliment may be accomplished by any method, e.g., as known in the art.

It may be noted that elements of storing device 100, storing device 200 and storing device 300, as specified herein, may he made of any suitable material such as, for example, plastic, wood, and the like.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A storage device for accommodating an item, the storage device comprising a stick handle that is coupled to an aliment, said storage device further comprising:
a housing designed to accommodate said item, wherein said housing comprises an opening that enables a user to take out said item from said housing.

2. The storage device according to claim 1, wherein said item is at least one of the following: a napkin, a flyer and a game.

3. The storage device according to claim 1, wherein said housing is integrated within said stick handle of said storage device.

4. The storage device according to claim 1, wherein said housing is detachably coupled to said stick handle of said storage device.

5. The device of claim 3, wherein said housing is a hollow shaft within said stick handle.

6. The device of claim 1, wherein said housing is closeable such the said item therein is not subjected to said aliment.

7. The device of claim 1, wherein said stick handle is coupled to said aliment by means of pushing said stick handle into said aliment.

8. The device of claim 1, wherein said aliment is at least one of the following: a Popsicle and a fruit.

9. The device of claim 1, wherein said opening is closeable by a detachable cap.

10. The device of claim 4, wherein said housing includes a slit that is slightly narrower than the widest width of a posterior portion of said stick handle, such that said posterior portion of said stick handle is able to frictionally receive said housing.

11. The device according to claim 9, wherein said housing comprises at least one stopper that is positioned such that stick handle is slidably insertable into said housing only up to the portion in which said item is accommodated.

12. The device according to claim 9, wherein a side of said housing has a cutout section that extends to about the center of said housing, thus enabling the user access to said item.

13. The device according to claim 4, wherein said housing and said stick handle have a substantially cylindrical shape, wherein the inner diameter of said housing is slightly larger than the outer diameter of said stick handle, such that said stick handle is designed to frictionally receive said housing.

14. The device according to claim 4, wherein said stick handle includes a substantially cylindrical element that is fixedly coupled proximate to the posterior end of stick handle, wherein said substantially cylindrically element comprises of a first and a second substantially cylindrical surface that are approximately concentrically aligned, wherein the diameter of said first substantially cylindrical surface is slightly larger than the inner diameter of said housing, and said first substantially cylindrical element being proximate to the posterior end of said stick handle, such that said first cylindrical surface is able to frictionally receive said housing.

15. The device according to claim 14, wherein said second substantially cylindrical surface has a diameter that corresponds to the outer diameter of said housing, such that said second substantially cylindrical surface provides a stopper function that limits the further frictional receiving of said housing.

16. The device according to claim 14, wherein said second substantially cylindrical surface has a diameter that exceeds the outer diameter of said housing such that said second substantially cylindrical surface provides a stopper function that limits the further frictional receiving of said housing.

17. The device according to claim 14, wherein said first and said second substantially cylindrical surfaces are integrally formed with each other.

18. The device according to claim 14, wherein said first and said second substantially cylindrical surfaces are joined to each other.

19. A method for inserting a napkin into a stick handle coupled to an aliment, the method comprising the following steps:
a. opening a housing;
b. inserting napkin into said housing;
c. closing said housing; and
d. coupling said stick handle to an aliment.
